(19) United States
(12) Patent Application Publication
(10) Pub. No.: US 2025/0000294 A1
(43) Pub. Date: Jan. 2, 2025

(54) BEVERAGE PREPARATION EQUIPMENT

(71) Applicant: Food Industry Research and Development Institute, Hsinchu (TW)

(72) Inventors: Jia-Yan HOU, Tainan City (TW); Feng-Chi LIU, Tainan City (TW)

(21) Appl. No.: 18/426,532

(22) Filed: Jan. 30, 2024

(30) Foreign Application Priority Data
Jun. 27, 2023 (TW) 112123874

(51) Int. Cl. A47J 31/41; A47J 31/40; A47J 31/44; A47J 31/46; A47J 31/52; B01F 23/40; B01F 23/43; B01F 33/452; B01F 35/00; B01F 35/21; B01F 35/22; B01F 35/221; B01F 35/222; B67D 1/00; B01F 101/14

(52) U.S. Cl. CPC A47J 31/41; A47J 31/402; A47J 31/4425; A47J 31/4492; A47J 31/469; A47J 31/5251; B01F 23/43; B01F 23/49; B01F 33/452; B01F 35/187; B01F 35/2112; B01F 35/2113; B01F 35/2117; B01F 35/2202; B01F 35/2207; B01F 35/2211; B01F 35/222; B67D 1/002; A47J 2203/00; B01F 2101/14

(57) ABSTRACT

A beverage preparation equipment includes a weighing unit, a mixing unit, a supply module, and a control unit. The weighing unit is configured to allow the cup to be placed thereon and to measure a weight of an object placed thereon. The mixing unit is configured to stir content contained therein and to output the content to the cup. The supply module is configured to supply an ingredient to the mixing unit. The control unit is configured to control the supply module to supply a predetermined volume of the ingredient to the mixing unit based on a command related to preparation of a beverage, control the mixing unit to stir the ingredient inputted thereto into the beverage and then output the beverage to the cup, and control the mixing unit to stop outputting the beverage based on the weight of the object and a predetermined weight indicated by the command.

### CROSS-REFERENCE TO RELATED APPLICATION

This application claims priority to Taiwanese Invention Patent Application No. 112123874, filed on Jun. 27, 2023 and incorporated by reference herein in its entirety.

### FIELD

The disclosure relates to a beverage preparation equipment, and more particularly to a beverage preparation equipment for automatically preparing a beverage.

### BACKGROUND

On-site prepared beverages offer a wide range of customizable beverage options for a customer to choose from, and are thus popular among the public. However, business challenges for selling on-site prepared beverages include pesticide residue on raw materials, excessive bacteria on ice cubes, quality control (flavor, ingredients, etc.), high turnover rates of employees, etc. A conventional semi-automatic equipment, such as a tea brewer disclosed in Taiwanese Utility Model Patent No. M622132, may be introduced into beverage shops to assist preparation of beverages and to reduce labor; however, the conventional semi-automatic equipment still requires occasional manual preparation of beverages by personnel.

### SUMMARY

Therefore, an object of the disclosure is to provide a beverage preparation equipment that can alleviate at least one of the drawbacks of the prior art.

According to the disclosure, a beverage preparation equipment for automatically preparing a beverage and filling a cup with the beverage is provided. The beverage preparation equipment includes a weighing unit, a mixing unit, an ingredient supply module, and a control unit. The weighing unit is configured to allow the cup to be placed thereon and to measure a weight of an object placed thereon. The mixing unit is configured to stir content contained therein into a mixture and to output the mixture to the cup. The ingredient supply module is configured to supply an ingredient to the mixing unit. The control unit is electrically connected to the weighing unit, the mixing unit, and the ingredient supply module, and is configured to control the ingredient supply module to supply a predetermined volume of the ingredient to the mixing unit based on a preparation command that is related to preparation of a beverage, control the mixing unit to stir the ingredient inputted thereto into the beverage and then output the beverage in the mixing unit to the cup, determine a weight of the beverage in the cup based on the weight of the object measured by the weighing unit, and control the mixing unit to stop outputting the beverage in the mixing unit to the cup when determining that the weight of the beverage in the cup has reached a predetermined weight indicated by the preparation command.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a beverage preparation equipment according to a first embodiment of the disclosure.

FIG. 2 is a schematic view illustrating structures of the beverage preparation equipment according to the first embodiment of the disclosure.

FIG. 3 is a block diagram illustrating a beverage preparation equipment according to a second embodiment of the disclosure.

FIG. 4 is a schematic view illustrating structures of the beverage preparation equipment according to the second embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, when referring to a component being “connected to” another component, the phrase “connected to” indicates that the two components are in spatial communication. Further, the term “electrically connected to” may refer to a direct connection between two electrical components via an electrically conductive material (e.g., an electrical wire), or an indirect connection between two electrical components via another one or more components, or wireless communication. In addition, the term “mechanically connected to” may refer to a connection between two components in a mechanical way, such as a connection through a mechanical linkage, a gear set, welding, etc.

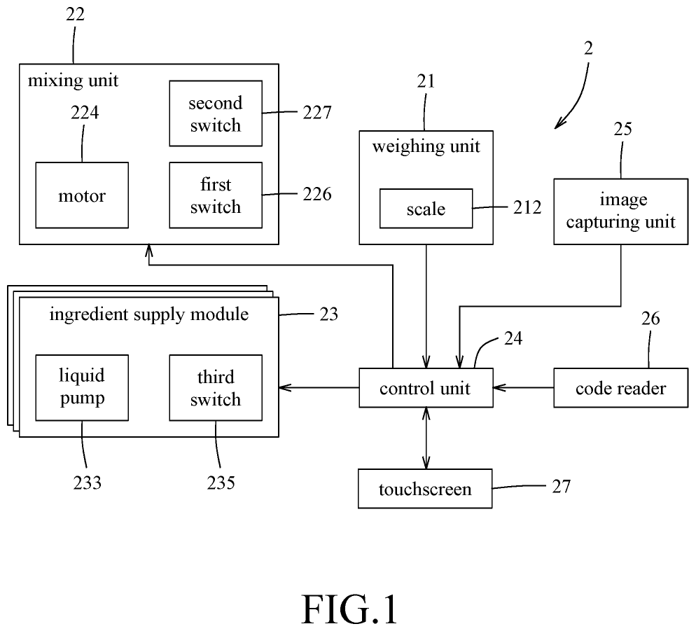

Referring to FIG. 1, a beverage preparation equipment 2 according to a first embodiment of the disclosure is provided. The beverage preparation equipment 2 includes a weighing unit 21, a mixing unit 22, a plurality of ingredient supply modules 23, and a control unit 24. The weighing unit 21 is configured to allow the cup 1 to be placed thereon and to measure a weight of an object placed thereon. The mixing unit 22 is configured to stir content contained therein into a mixture and to output the mixture to the cup 1. Each of the ingredient supply modules 23 may store a specific ingredient (e.g., juice, condensed juice, syrup, tea, boiled water, water), and is configured to supply the ingredient stored therein to the mixing unit 22. The control unit 24 is electrically connected to the weighing unit 21, the mixing unit 22, and the ingredient supply modules 23, so as to receive the weight of the object from the weighing unit 21, and to control operation of the mixing unit 22 and the ingredient supply modules 23.

The control unit 24 is configured to, upon receiving a preparation command that is related to preparation of a beverage, select those of the ingredient supply modules 23 that store the ingredients of the beverage based on the preparation command (hereinafter referred to as “selected ingredient supply modules”), control each of the selected ingredient supply modules 23 to supply a predetermined volume of the ingredient to the mixing unit 22 based on the preparation command, and to control the mixing unit 22 to stir the ingredients inputted thereto into the beverage and then output the beverage in the mixing unit 22 to the cup 1. The control unit 24 is further configured to determine a weight of the beverage in the cup 1 based on the weight of the object measured by the weighing unit 21. The control unit 24 is further configured to determine whether the weight of the beverage in the cup 1 has reached a predetermined weight that is indicated by the preparation command, and to control the mixing unit 22 to stop outputting the beverage in the mixing unit 22 to the cup 1 when the determination is affirmative.

For each of selected ingredient supply modules 23, when the control unit 24 determines that the predetermined volume of the ingredient that was supplied to the mixing unit 22 from the ingredient supply module 23 has been completely outputted from the mixing unit 22 (for example, wait for a predetermined time period (e.g., two seconds) after the mixing unit 22 has started outputting the beverage) and that the weight of the beverage in the cup 1 has not reached the predetermined weight, the control unit 24 is further configured to control the ingredient supply module 23 to continuously supply the ingredient to the mixing unit 22, control the mixing unit 22 to continuously stir the ingredients inputted thereto, and control the mixing unit 22 to continuously output the beverage to the cup 1, until determining that the weight of the beverage in the cup 1 has reached the predetermined weight indicated by the preparation command. As such, the equipment 2 may automatically fill the cup 1 with the predetermined weight of the beverage.

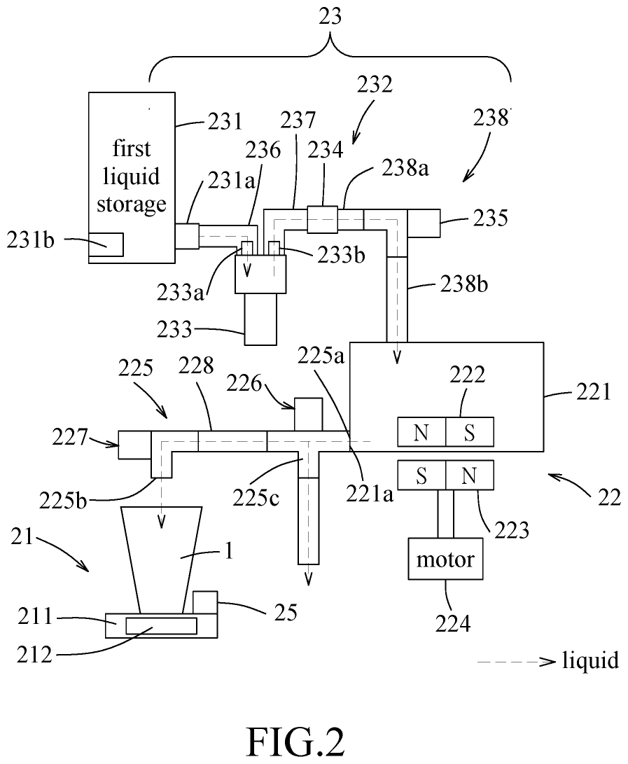

Further referring to FIG. 2, the weighing unit 21 includes a platform 211 that is configured to allow the cup 1 to be disposed thereon, and a scale 212 that is disposed inside the platform 211 and that is configured to measure the weight of the object that is disposed on the platform 211. The weighing unit 21 may provide the weight of the object to the control unit 24 so that the control unit 24 may obtain the weight of the beverage in the cup 1 based on the weight of the object. In some embodiments, a weight of the cup 1 that is placed on the platform 211 is pre-stored in the control unit 24, and the control unit 24 may obtain the weight of the beverage in the cup 1 by subtracting the weight of the object by the weight of the cup 1. In some embodiments, the weighing unit 21 is configured to automatically calibrate weight measurement to zero right after the cup 1 is placed onto the platform 211, and the weight of the object measured by the scale 212 is equal to the weight of the beverage in the cup 1.

The mixing unit 22 includes a container 221 that is configured to contain the ingredients, a motor 224 that is electrically connected to the control unit 24 and that is controlled by the control unit 24 to operate, and a mixer that is mechanically connected to the motor 224 and that is configured to be driven by the motor 224 to stir the ingredients in the container 221. In this embodiment, the mixer includes, but is not limited to, a magnetic rod 222 and a magnet 223. The magnet 223 is disposed outside the container 221, is mechanically connected to the motor 224, and is configured to be driven by the motor 224 to rotate. The magnetic rod 222 is disposed in the container 221 and is magnetically attracted by the magnet 223 so as to co-rotate with the magnet 223 for stirring the ingredients in the container 221. In some embodiments, the mixer may be a mixing blade that is configured to be driven by the motor 224 to rotate for stirring and blending the ingredient in the container 221.

The container 221 includes an outlet 221a for outputting the beverage, and the mixing unit 22 further includes a first pipe unit 225 that is connected to the outlet 221a of the container 221 and that is adapted to output the beverage from the container 221 to the cup 1. The first pipe unit 225 includes an input port 225a that is connected to the outlet 221a of the container 221, a connection pipe 228, and a first output port 225b and a second output port 225c that are connected to each other by the connection pipe 228, that are in spatial communication with the input port 225a, and that are adapted to output the beverage inputted from the container 221 through the input port 225a. The first output port 225b is disposed above the weighing unit 21 so that the beverage may be outputted to the cup 1 that is disposed on the weighing unit 21 through the first output port 225b. The second output port 225c may be used for disposal of remaining beverage that is in the container 221 after the mixing unit 22 has stopped outputting the beverage to the cup 1. It should be noted that the first pipe unit 225 allows the beverage to flow from the container 221 to the first output port 225b and the second output port 225c under the principle of communicating vessels or gravity.

The first pipe unit 225 further includes a first switch 226 that is controlled by the control unit 24 to allow the beverage to flow into the first pipe unit 225 through the input port 225a and to control the flow of the beverage to either the first output port 225b or the second output port 225c. The first pipe unit 225 further includes a second switch 227 that is controlled by the control unit 24 to allow the beverage to flow out from the first output port 225b. In this embodiment, each of the first switch 226 and the second switch 227 may be, but is not limited to, a solenoid valve. Specifically, the first switch 226 has three ports, one of the three ports is connected to one end of the connection pipe 228, and the remaining two of the three ports are connected respectively to the input port 225a and the second output port 225c or are used respectively as the input port 225a and the second output port 225c; the second switch 227 has two ports, one of the two ports is connected to the other end of the connection pipe 228, and the other one of the two ports is connected to the first output port 225b or is used as the first output port 225b.

In the first embodiment shown in FIG. 2, the ingredient is liquid, and each of the ingredient supply modules 23 delivers the ingredient stored therein using a mechanical pump. Since the ingredient supply modules 23 of the first embodiment are similar to one another, only one ingredient supply module 23 is shown in FIG. 2 and is described in the following. The ingredient supply module 23 of the first embodiment includes a liquid storage 231 that is configured to store the ingredient (e.g., juice, condensed juice, syrup, tea, boiled water, water), and that includes a liquid storage output port 231a for outputting the ingredient stored in the liquid storage 231. The ingredient supply module 23 further includes a liquid transport unit 232 that is configured to transport the ingredient from the liquid storage 231 to the mixing unit 22, and that includes a first pipe 236, a second pipe 237, a second pipe unit 238, a liquid pump 233, and a stabilizer 234.

The liquid pump 233 is controlled by the control unit 24 and includes a liquid pump input port 233a that is connected to the liquid storage output port 231a through the first pipe 236, and a liquid pump output port 233b that is connected to one end of the stabilizer 234 through the second pipe 237. The liquid pump 233 is configured to, under control of the control unit 24, pump the ingredient from the liquid storage 231 to the mixing unit 22 through the second pipe 237, the stabilizer 234, and the second pipe unit 238.

The other end of the stabilizer 234 is connected to the container 221 through the second pipe unit 238. The stabilizer 234 is configured to stabilize a flow rate of the ingredient flowing from the liquid pump 233 to the mixing unit 22, and has an inner diameter that is uniform and that is smaller than an inner diameter of the first pipe 236, such that the stabilizer 234 can suppress any turbulence in the flow of the ingredient through the stabilizer 234, thus maintaining the flow rate of the ingredient at a predetermined flow rate (e.g., 100 milliliters per second). It should be noted that the predetermined flow rate may be set according to user requirements and is not limited to the abovementioned example.

The second pipe unit 238 includes a third pipe 238a, a fourth pipe 238b and a third switch 235. The third switch 235 has one end connected to the stabilizer 234 through the third pipe 238a (i.e., the third pipe 238a is connected to one end of the stabilizer 234), and the other end connected to the container 221 through the fourth pipe 238b (i.e., the fourth pipe 238b is connected to the mixing unit 22). The third switch 235 is controlled by the control unit 24 to allow the ingredient to flow through the second pipe unit 238 into the container 221. In this embodiment, the third switch 235 may be, but is not limited to, a solenoid valve having two ports connected respectively to the third pipe 238a and the fourth pipe 238b.

The control unit 24 may obtain a total volume of the ingredient that has been outputted from the liquid storage 231 to the container 221 based on the predetermined flow rate and a time period of the second pipe unit 238 outputting the ingredient, and may then determine whether the total volume thus obtained has reached the predetermined volume of the ingredient as indicated by the preparation command.

The control unit 24 may be, but is not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), and/or a system on a chip (SoC), etc. The control unit 24 is electrically connected to the scale 212 of the weighing unit 21, the motor 224 of the mixing unit 22, the first switch 226, the second switch 227, the liquid pump(s) 233 and the third switch(s) 235 of the ingredient supply module(s) 23, so as to control operation of the various components.

The following provides an example that the preparation command is related to preparation of a beverage that is made of various ingredients respectively from some of the ingredient supply modules 23 (selected ingredient supply modules 23). It should be noted that the predetermined volumes of the ingredients respectively from the selected ingredient supply modules 23 for making the beverage may be different.

For example, when the control unit 24 controls, for each of the selected ingredient supply modules 23, the liquid pump 233 and the third switch 235 to operate so as to deliver the ingredient stored in the liquid storage 231 to the container 221, the control unit 24 further controls the motor 224 of the mixing unit 22 to operate so as to drive the magnetic rod 222 to stir the ingredients from the selected ingredient supply modules 23 in the container 221, and controls the first switch 226 to prevent the beverage from flowing out of the container 221 from the outlet 221a. For each of the selected ingredient supply modules 23, when the ingredient delivered to the container 221 has reached a predetermined portion of the predetermined volume where the predetermined portion may be preset by the control unit 24, the control unit 24 controls the liquid pump 233 and the third switch 235 to stop delivering the ingredient from the liquid storage 231 to the container 221, controls the first switch 226 to allow the beverage to flow into the first pipe unit 225 through the input port 225a only to the first output port 225b, and then controls the second switch 227 to allow the beverage to flow out from the first output port 225b to the cup 1 that is disposed on the weighing unit 21. The control unit 24 may repeat the abovementioned operation multiple times until the total volume of the ingredient cumulated from the predetermined portions delivered respectively in multiple stages has reached the predetermined volume as indicated by the preparation command. As such, the ingredient(s) inputted to the container 221 may be fully stirred before being outputted from the outlet 221a. In addition, a capacity of the container 221 may be reduced (e.g., less than 300 ml) so that the container 221 would only require a small amount of water for cleaning, where the water for cleaning may be stored in the liquid storage 231 of one of the ingredient supply modules 23.

In some embodiments, the control unit 24 may control the selected ingredient supply modules 23 to deliver the predetermined volumes of the ingredients as indicated by the preparation command to the container 221 in one operation (instead of delivering the predetermined portion in multiple stages), control the motor 224 to drive the magnetic rod 222 to stir the ingredients in the container 221, and only after the ingredients in the container 221 are fully mixed into the beverage, control the first switch 226 to allow the beverage to flow out of the container 221 through the outlet 221a only to the first output port 225b, and then control the second switch 227 to allow the beverage to flow out from the first output port 225b to the cup 1 that is disposed on the weighing unit 21.

In some embodiments, the control unit 24 may control the selected ingredient supply modules 23 to deliver the predetermined volumes of the ingredients as indicated by the preparation command to the container 221 in one operation, control the motor 224 to drive the magnetic rod 222 to stir the ingredients in the container 221, and while the magnetic rod 222 is stirring the ingredients in the container 221, the control unit 24 simultaneously controls the first switch 226 to allow the beverage to flow out of the container 221 through the outlet 221a only to the first output port 225b, and then control the second switch 227 to allow the beverage to flow out from the first output port 225b to the cup 1 that is disposed on the weighing unit 21. The control unit 24 may control the selected ingredient supply modules 23 to stop delivering the ingredients to the container 221 and control the magnetic rod 222 to stop stirring when determining that the total volume of the ingredient that has been inputted to the container 221 from each of the selected ingredient supply modules 23 has reached the predetermined volume of ingredient. In some embodiments, for each of the selected ingredient supply modules 23, the control unit 24 may control the selected ingredient supply module 23 to stop delivering the ingredient to the container 221 when determining that the total volume of the ingredient that has been inputted to the container 221 from the selected ingredient supply module 23 has reached the predetermined volume, and then control the magnetic rod 222 to stop stirring when determining that, for each of the selected ingredient supply modules 23, the total volume of the ingredient that has been inputted to the container 221 from the selected ingredient supply module 23 has reached the predetermined volume.

When the control unit 24 determines that the weight of the beverage in the cup 1 has reached the predetermined weight, the control unit 24 controls the second switch 227 to stop outputting the beverage from the first output port 225b, controls the first switch 226 to allow the beverage to flow out from the outlet 221a to the second output port 225c, and controls one of the ingredient supply modules 23 that stores the water for cleaning to output the water to the container 221 so as to clean the container 221. The water used for cleaning the container 221 and any of the beverage that is left in the first pipe unit 225 may be outputted from the second output port 225c for disposal.

In this embodiment, the liquid storage 231 is a pouch that is replaceable, and the control unit 24 is configured to determine whether the ingredient in the liquid storage 231 is insufficient by calculating a cumulative volume of the ingredient that has been outputted from the liquid storage 231. The control unit 24 is further configured to, when determining that the ingredient in the liquid storage 231 is insufficient, generate and output a first alert message that is related to insufficient ingredients in the liquid storage 231 so as to remind a personnel to replace the liquid storage 231 with a new pouch.

In this embodiment, the beverage preparation equipment 2 further includes an image capturing unit 25 that is disposed on the platform 211 and that is electrically connected to the control unit 24. The image capturing unit 25 may be a camera that is configured to capture an image of the object placed on the platform 211 and to send the image to the control unit 24. The control unit 24 is configured to identify the object in the image using an image recognition module disposed therein (e.g., an image recognition software coded in python or other programming languages, not shown). The control unit 24 is further configured to, when determining that the object in the image is not a cup or the object is not placed on the platform 211 properly based on the image and the object thus identified, generate and output a second alert message that is related to the object so as to remind the personnel to replace the object on the platform 211 or to adjust the position of the cup 1 to a proper position.

In this embodiment, the beverage preparation equipment 2 further includes a code reader 26 electrically connected to the control unit 24. For each of the ingredient supply modules 23, the code reader 26 is configured to obtain material information of the ingredient stored in the liquid storage 231 by reading a barcode 231b that is disposed on the liquid storage 231 and that contains the material information, and to send the material information to the control unit 24. For each of the ingredient supply modules 23, the control unit 24 is configured to store pre-stored information that corresponds to the ingredient supply module 23, to compare the material information thus obtained with the pre-stored information, and when determining that the material information thus obtained does not conform with the pre-stored information (e.g., having different ingredient names, different composition, different expiration dates), to generate and output a third alert message that is related to the ingredient in the liquid storage 231 so as to remind the personnel to double check on whether the ingredient that is stored in the liquid storage 231 matches an ingredient as indicated by the pre-stored information, thus avoiding usage of ingredients of unknown origin.

It should be noted that the first alert message, the second alert message, and the third alert message may be in the form of a message or a symbol that can be displayed on a screen of the beverage preparation equipment 2, a light outputted by a light-emitting device of the beverage preparation equipment 2, a sound outputted by a speaker of the beverage preparation equipment 2, or a combination thereof.

In this embodiment, the beverage preparation equipment 2 further includes a touchscreen 27 that is electrically connected to the control unit 24. The control unit 24 is further configured to control the touchscreen 27 to display a user interface (not shown) that displays at least one option related respectively to at least one beverage on the user interface based on the material information of the ingredients stored in the ingredient supply modules 23. In some embodiments, the control unit 24 obtains the material information from a user input. In some embodiments, the control unit 24 obtains the material information by reading the barcodes 231b disposed respectively on the liquid storages 231 of the ingredient supply modules 23 with the code reader 26. After one of the at least one option is selected, the control unit 24 generates the preparation command based on the one of the at least one option that is selected and prepares the beverage based on the preparation command thus generated.

In some embodiments, after one of the at least one option is selected, the control unit 24 generates a beverage barcode that contains the preparation command based on the one of the at least one option that is selected. The beverage barcode thus generated may be presented through an output device (e.g., a printer, not shown), and the control unit 24 may obtain the preparation command by reading the beverage barcode thus presented using the code reader 26 of the beverage preparation equipment 2 or another code reader. The control unit 24 may then prepare the beverage based on the preparation command thus obtained. As such, when there are multiple customers making orders, the beverage preparation equipment 2 may first print out the beverage barcodes according to the orders made by the customers, and then prepare the beverages of the respective orders one by one by reading the beverage barcodes in order.

In one example, the beverage is delivered to the cup 1 through a multi-stage operation. If the option that is selected on the user interface is “black tea (500 ml) with half sugar (10 ml of syrup)”, then the preparation command generated by the control unit 24 is related to instructing one of the ingredient supply modules 23 that stores black tea to output 500 ml of black tea, and instructing another one of the ingredient supply modules 23 that stores syrup to output 10 ml of syrup. Then, for each of the two selected ingredient supply modules 23 that stores black tea and syrup, the control unit 24 controls the selected ingredient supply module 23 to output a predetermined portion of the predetermined volume of the ingredient to the mixing unit 22 in each stage of the operation. For example, the beverage preparation equipment 2 is configured to prepare the beverage in a five stage operation, each operation includes the ingredient supply module 23 that stores black tea outputting 100 ml of black tea, and the ingredient supply module 23 that stores syrup outputting 2 ml of syrup.

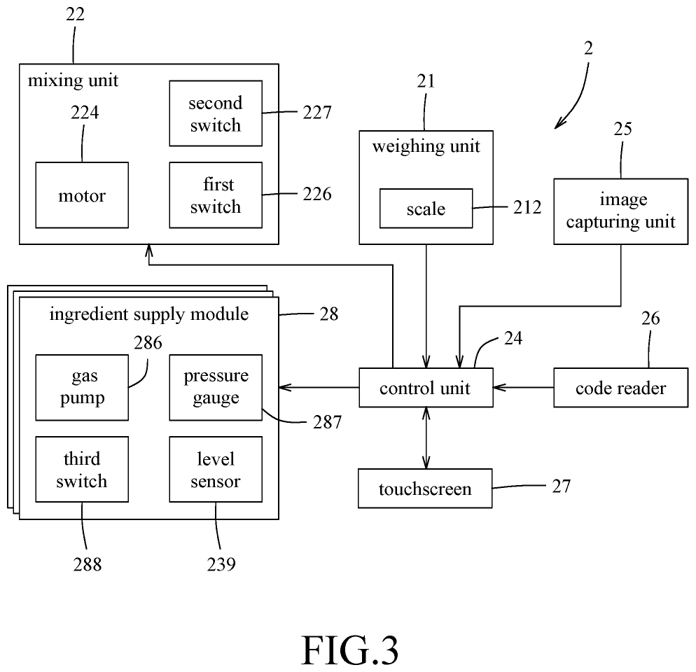

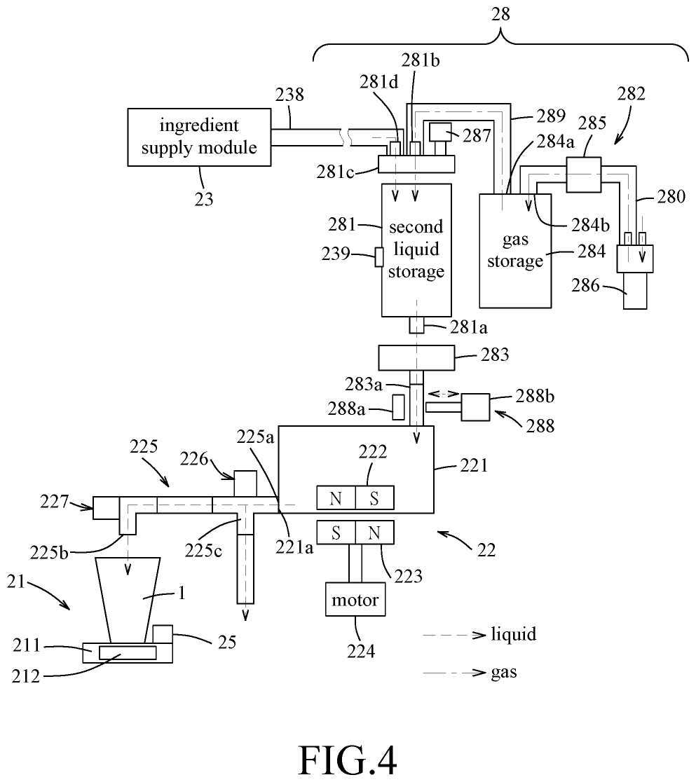

Referring to FIGS. 3 and 4, the beverage preparation equipment 2 according to a second embodiment of the disclosure is provided. The beverage preparation equipment 2 of the second embodiment includes the weighing unit 21, the mixing unit 22 and the control unit 24 that are similar to those of the first embodiment, and a plurality of ingredient supply modules 28. Different from the first embodiment, in the second embodiment, each of the ingredient supply modules 28 delivers the ingredient (liquid) stored therein using air pressure. Each of the ingredient supply modules 28 of the second embodiment includes a liquid storage 281 that is configured to store the ingredient, a liquid transport unit 282, and a holder 283. The liquid storage 281 includes a liquid storage output port 281a, a liquid storage input port 281b, and a lid 281c. The holder 283 includes a connection pipe 283a that is connected between the liquid storage output port 281a and the container 221. The liquid storage output port 281a is located at a lower end of the liquid storage 281, is mounted on the holder 283, and is connected to the connection pipe 283a for outputting the ingredient from the liquid storage 281 to the container 221 through the connection pipe 283a. The lid 281c is located at an upper end of the liquid storage 281, and the liquid storage input port 281b is disposed on the lid 281c and does not contact the ingredient stored in the liquid storage 281.

The liquid transport unit 282 includes a first pipe 289, a second pipe 280, a gas storage 284, a gas filter 285, a gas pump 286, a pressure gauge 287, and a third switch 288. The gas storage 284 is configured to store gas, and includes a gas storage output port 284a that is connected to the liquid storage input port 281b through the first pipe 289, and a gas storage input port 284b that is connected to the gas pump 286 through the second pipe 280. The gas pump 286 is configured to, under control of the control unit 24, operate so as to pump gas into the gas storage 284. The gas filter 285 is disposed on the second pipe 280 and is configured to filter out impurities and microorganisms from the gas that is pumped into the gas storage 284 by the gas pump 286. The pressure gauge 287 is disposed on the lid 281c of the liquid storage 281 and is electrically connected to the control unit 24. The pressure gauge 287 is configured to measure a pressure value of pressure of the gas in the liquid storage 281 and provide the pressure value to the control unit 24. The control unit 24 is further configured to determine whether the pressure of the gas in the liquid storage 281 is maintained at a predetermined pressure level based on the pressure value measured by the pressure gauge 287, and to control the gas pump 286 to, based on the pressure value measured by the pressure gauge 287, operate so as to maintain the pressure of the gas in the liquid storage 281 at the predetermined pressure level. In this embodiment, the predetermined pressure level may be adjusted (e.g., a range of 0.07 bar to 0.13 bar) according to different beverages to be prepared by the beverage preparation equipment 2, but the disclosure is not limited to such.

The third switch 288 is disposed between the liquid storage output port 281a and the container 221, and is electrically connected to the control unit 24. The third switch 288 is controlled by the control unit 24 to allow the ingredient stored in the liquid storage 281 to flow from the liquid storage output port 281a into the container 221. For each of the ingredient supply modules 28 that store the ingredients of the beverage indicated by the preparation command, the control unit 24 is configured to control the ingredient supply module 28 to supply the ingredient to the container 221 by controlling the gas pump 286 to operate so as to supply gas to the gas storage 284, thus allowing the gas storage 284 to supply gas to the liquid storage 281, and controlling the third switch 288 to allow the ingredient to flow from the liquid storage 281 into the container 221.

In this embodiment, the third switch 288 is a cut-off device that is disposed on an outer surface of the connection pipe 283a. The connection pipe 283a is a resilient pipe that may be squeezed when an external force is applied. The third switch 288 includes a blocking component 288a that is disposed at one side of the connection pipe 283a, and a cut-off component 288b that is disposed at the other side of the connection pipe 283a and that is at a position opposite to the blocking component 288a. The cut-off component 288b may be a pneumatic cylinder having a piston. The cut-off component 288b is configured to be controlled by the control unit 24 to move toward the blocking component 288a so as to squeeze the connection pipe 283a, thus blocking the ingredient from flowing to the container 221 through the connection pipe 283a, and to move away from the blocking component 288a, thus allowing the ingredient to flow to the container 221 through the connection pipe 283a. Specifically, the piston of the cut-off component 288b is moved toward the blocking component 288a, and then presses the connection pipe 283a, thereby squeezing the connecting pipe 283a together with the blocking component 288a. As such, the third switch 288 may avoid contacting or contaminating the ingredient. In some embodiments, the third switch 288 may be a pinch valve that is configured to be controlled by the control unit 24 to squeeze the connection pipe 283a.

When the ingredient is allowed to flow through the connection pipe 283a, the ingredient stored in the liquid storage 281 would flow from the liquid storage 281 to the container 221 under the influence of air pressure in the liquid storage 281. Since the air pressure in the liquid storage 281 is maintained at the predetermined pressure level, an output flow of the ingredient at the liquid storage output port 281a is maintained at a fixed flow rate (e.g., 100 milliliters per second). As such, the control unit 24 may obtain a total volume of the ingredient that has been outputted from the liquid storage 281 to the container 221 based on the fixed flow rate and a time period of the liquid storage output port 281a outputting the ingredient. It should be noted that the fixed flow rate may be set according to user requirements and is not limited to the abovementioned example.

Each of the ingredient supply modules 28 further includes a level sensor 239 that is disposed on the liquid storage 281 and that is electrically connected to the control unit 24. The level sensor 239 is configured to detect a level value of a liquid level of the ingredient in the liquid storage 281 and to send the level value to the control unit 24. The control unit 24 is further configured to, when determining that the liquid level of the ingredient in the liquid storage 281 is out of a predetermined range based on the level value, generate and output a fourth alert message that is related to the liquid level of the ingredient so as to remind the personnel to replace or refill the liquid storage 281 when the ingredient in the liquid storage 281 is insufficient, or to stop refilling the ingredient to the liquid storage 281 when the ingredient in the liquid storage 281 is excessive.

For example, the control unit 24 determines that the ingredient in the liquid storage 281 is insufficient when the level value is below the predetermined range, and determines that the ingredient in the liquid storage 281 is excessive when the level value is above the predetermined range.

In some embodiments, the liquid storage 281 is a storage container that is replaceable, and the fourth alert message may remind the personnel to replace the liquid storage 281 with a new storage container.

In some embodiments, the lid 281c of the liquid storage 281 may further include a supply port 281d disposed thereon (as shown in FIG. 4), and the liquid storage 281 may be refilled by another ingredient supply module. For example, the ingredient supply module 23 of the first embodiment may be connected to the liquid storage 281 of the second embodiment for refilling the liquid storage 281 by connecting the second pipe unit 238 of the ingredient supply module 23 to the supply port 281d of the liquid storage 281. The fourth alert message may be a refill command that instructs the ingredient supply module 23 to resupply the ingredient to the liquid storage 281. In addition, the material information of the ingredient that is stored in the ingredient supply modules 28 is obtained by reading the barcode on the ingredient supply module 23 that is used to refill the ingredient supply modules 28. It should be noted that the fourth alert message may be in the form of a message or a symbol that can be displayed on a screen of the beverage preparation equipment 2, a light outputted by a light-emitting device of the beverage preparation equipment 2, a sound outputted by a speaker of the beverage preparation equipment 2, or a combination thereof.

It should be noted that in the second embodiment, components of the beverage preparation equipment 2, except the ingredient supply modules 28, are configured to operate in the same manner as in the first embodiment, and will not be described in detail for the sake of brevity.

In practice, the beverage preparation equipment 2 may include the ingredient supply module 23 of the first embodiment or the ingredient supply module 28 of the second embodiment depending on a viscosity of the ingredient that is to be provided. In one example, when the viscosity of the ingredient to be provided is less than 820 centipoise (cp), the beverage preparation equipment 2 may use the ingredient supply module 23 of the first embodiment to deliver the ingredient to the container 221; when the viscosity of the ingredient to be provided is less than 1200 cp and greater than or equal to 820 cp, the beverage preparation equipment 2 may use the ingredient supply module 28 of the second embodiment to deliver the ingredient to the container 221.

In some embodiments, the control unit 24 may further communicate with a cloud database (not shown), where the cloud database stores recipes respectively of a plurality of beverages and operation parameter sets related respectively to preparation of the beverages. The personnel may control the control unit 24 through the user interface to download the recipes and the operation parameter sets from the cloud database, and the preparation command may be generated based on the recipes and the operation parameter sets thus downloaded, and may upload business data (e.g., sales quantity of different beverages, flavors with high popularity, whether ingredient inventory needs to be replenished, equipment usage status, component operation time) to the cloud database.

In summary, according to the disclosure, the control unit 24 is configured to control the selected ingredient supply modules 23, 28 to output the predetermined volumes of the ingredients to the container 221 based on the preparation command, to control the mixing unit 22 to stir the ingredients therein and then output the beverage to the cup 1, and to determine whether the weight of the beverage in the cup 1 has reached the predetermined weight that is indicated by the preparation command. When the determination is affirmative, the control unit 24 controls the mixing unit 22 to stop outputting the beverage to the cup 1. As such, the beverage may be automatically prepared and filled into the cup 1 by the beverage preparation equipment 2.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A beverage preparation equipment for automatically preparing a beverage and filling a cup with the beverage, said beverage preparation equipment comprising:
a weighing unit configured to allow the cup to be placed thereon and to measure a weight of an object placed thereon;
a mixing unit configured to stir content contained therein into a mixture and to output the mixture to the cup;
an ingredient supply module configured to supply an ingredient to said mixing unit; and
a control unit electrically connected to said weighing unit, said mixing unit, and said ingredient supply module, said control unit being configured to
control said ingredient supply module to supply a predetermined volume of the ingredient to said mixing unit based on a preparation command that is related to preparation of a beverage,
control said mixing unit to stir the ingredient inputted thereto into the beverage and then output the beverage in said mixing unit to the cup,
determine a weight of the beverage in the cup based on the weight of the object measured by said weighing unit, and
control said mixing unit to stop outputting the beverage in said mixing unit to the cup when determining that the weight of the beverage in the cup has reached a predetermined weight indicated by the preparation command.

2. The beverage preparation equipment as claimed in claim 1, wherein said control unit is further configured to, when determining that the predetermined volume of the ingredient that was supplied to said mixing unit from said ingredient supply module has been completely outputted from said mixing unit and that the weight of the beverage in the cup has not reached the predetermined weight, control said ingredient supply module to continuously supply the ingredient to said mixing unit, control said mixing unit to continuously stir the ingredient inputted thereto, and control said mixing unit to continuously output the beverage to the cup, until determining that the weight of the beverage in the cup has reached the predetermined weight.

3. The beverage preparation equipment as claimed in claim 1, wherein said mixing unit includes a container that is configured to contain the ingredient, a motor that is electrically connected to said control unit and that is controlled by said control unit to operate, and a mixer that is mechanically connected to said motor and that is configured to be driven by said motor to stir the ingredient in said container.

4. The beverage preparation equipment as claimed in claim 3, wherein said mixer includes a magnet that is disposed outside said container, that is mechanically connected to said motor, and that is configured to be driven by said motor to rotate, and a magnetic rod that is disposed in said container and that is magnetically attracted by said magnet so as to co-rotate with said magnet for stirring the ingredient in said container.

5. The beverage preparation equipment as claimed in claim 3, wherein said container includes an outlet for outputting the beverage, and said mixing unit further includes:
a first pipe unit that is connected to said container and that is adapted to output the beverage from said container to the cup, wherein said first pipe unit includes an input port that is connected to said outlet of said container, a connection pipe, and a first output port and a second output port that are connected to each other by said connection pipe, that are in spatial communication with said input port, and that are adapted to output the beverage inputted from said container through said input port, said first output port being disposed above said weighing unit;
a first switch controlled by said control unit to allow the beverage to flow into said first pipe unit through said input port and to control flow of the beverage to one of said first output port and said second output port; and
a second switch controlled by said control unit to allow the beverage to flow out from said first output port.

6. The beverage preparation equipment as claimed in claim 1, wherein the ingredient is liquid, and said ingredient supply module includes:
a liquid storage that is configured to store the ingredient, and that includes a liquid storage output port for outputting the ingredient stored in said liquid storage; and
a liquid transport unit that is configured to transport the ingredient from said liquid storage to said mixing unit, and that includes
a first pipe,
a second pipe,
a liquid pump that is controlled by said control unit and that includes a liquid pump input port connected to said liquid storage output port through said first pipe, and a liquid pump output port,
a stabilizer that is configured to stabilize a flow rate of the ingredient flowing from said liquid pump to said mixing unit, and that has one end connected to said liquid pump output port through said second pipe, and
a second pipe unit that includes a third pipe that is connected to the other end of said stabilizer, a fourth pipe that is connected to said mixing unit, and a switch that has one end connected to said third pipe and the other end connected to said fourth pipe, and is controlled by said control unit to allow the ingredient to flow through said second pipe unit into said mixing unit,
wherein said control unit is further configured to control said liquid pump to pump the ingredient from said liquid storage to said mixing unit through said second pipe, said stabilizer, and said second pipe unit.

7. The beverage preparation equipment as claimed in claim 6, further comprising a code reader electrically connected to said control unit, said code reader being configured to obtain material information of the ingredient stored in said liquid storage by reading a barcode that is disposed on said liquid storage and that contains the material information, and to send the material information to said control unit,
wherein said control unit is configured to store pre-stored information that corresponds to said ingredient supply module, to compare the material information thus obtained with the pre-stored information, and to generate and output an alert message when the material information thus obtained does not conform with the pre-stored information.

8. The beverage preparation equipment as claimed in claim 1, wherein the ingredient is liquid, and said ingredient supply module includes:
a liquid storage that is configured to store the ingredient, and that includes a liquid storage output port located at a lower end of said liquid storage for outputting the ingredient from said liquid storage to said mixing unit, and a liquid storage input port located at an upper end of said liquid storage; and
a liquid transport unit that includes
a first pipe,
a gas storage configured to store gas, said gas storage including a gas storage output port and being connected to said liquid storage input port through said first pipe, and
a switch electrically connected to said control unit, said switch being disposed between said liquid storage output port and said mixing unit and controlled by said control unit to allow the ingredient stored in said liquid storage to flow from said liquid storage into said mixing unit,
wherein said control unit is configured to control said ingredient supply module to supply the ingredient to said mixing unit by allowing said gas storage to supply gas to said liquid storage and controlling said switch to allow the ingredient to flow from said liquid storage into said mixing unit.

9. The beverage preparation equipment as claimed in claim 8, wherein said gas storage further includes a gas storage input port, and said liquid transport unit further includes:
a second pipe;
a gas pump connected to said gas storage input port through said second pipe and configured to pump gas to said gas storage; and
a pressure gauge electrically connected to said control unit, said pressure gauge being disposed on said liquid storage and configured to measure a pressure value of pressure of the gas in said liquid storage and provide the pressure value to said control unit;
wherein said control unit is further configured to control said gas pump to operate so as to pump gas into said gas storage, and to, based on the pressure value measured by said pressure gauge, maintain the pressure of the gas in said liquid storage at a predetermined pressure level.

10. The beverage preparation equipment as claimed in claim 9, wherein said liquid transport unit further includes a gas filter that is disposed on said second pipe and that is configured to filter out impurities and microorganisms from the gas that is pumped into said gas storage by said gas pump.

11. The beverage preparation equipment as claimed in claim 8, wherein:
said liquid transport unit further includes a holder, said liquid storage output port is mounted on said holder, and said holder includes a connection pipe that is connected between said liquid storage output port and said mixing unit;
said liquid storage further includes a lid, and said liquid storage input port is disposed on said lid; and
said switch includes a blocking component that is disposed at one side of said connection pipe, and a cut-off component that is disposed at the other side of said connection pipe and that is controlled by said control unit to move toward said blocking component so as to block the ingredient from flowing to said mixing unit through said connection pipe, and to move away from said blocking component so as to allow the ingredient to flow to said mixing unit through said connection pipe.

12. The beverage preparation equipment as claimed in claim 8, wherein:
said ingredient supply module further includes a level sensor that is electrically connected to said control unit, that is disposed on said liquid storage, and that is configured to detect a level value of a liquid level of the ingredient in said liquid storage and to send the level value to said control unit, and
said control unit is configured to generate and output an alert message when determining, based on the level value, that the liquid level of the ingredient in said liquid storage is out of a predetermined range.

13. The beverage preparation equipment as claimed in claim 8, further comprising a code reader electrically connected to said control unit, said code reader being configured to obtain material information of the ingredient stored in said liquid storage by reading a barcode that is disposed on said liquid storage and that contains the material information, and to send the material information to said control unit,
wherein said control unit is configured to store pre-stored information that corresponds to said ingredient supply module, to compare the material information thus obtained with the pre-stored information, and to generate and output an alert message when the material information thus obtained does not conform with the pre-stored information.

14. The beverage preparation equipment as claimed in claim 1, further comprising an image capturing unit electrically connected to said control unit, wherein:
said weighing unit includes a platform that is configured to allow the cup to be disposed thereon, and a scale that is disposed inside said platform and that is configured to measure the weight of the object placed on said platform;
said image capturing unit is disposed on said platform and is configured to capture an image of the object placed on said platform, and to send the image to said control unit; and
said control unit is further configured to identify the object in the image, and to generate and output an alert message when determining, based on the image and the object thus identified, one of a first condition where the object is not a cup and a second condition where the object is not placed on said platform properly.

15. The beverage preparation equipment as claimed in claim 1, further comprising a touchscreen that is electrically connected to said control unit,
wherein said control unit is further configured to control said touchscreen to display a user interface that displays at least one option related to the beverage on the user interface based on material information of the ingredient stored in said ingredient supply module, and to generate the preparation command based on one of the at least one option that is selected.

16. The beverage preparation equipment as claimed in claim 1, further comprising a touchscreen that is electrically connected to said control unit,
wherein said control unit is further configured to control said touchscreen to display a user interface that displays at least one option related to the beverage on the user interface based on material information of the ingredient stored in said ingredient supply module, to generate a barcode that contains the preparation command based on one of the at least one option that is selected, to present the barcode thus generated through an output device, and to obtain the preparation command from a code reader that reads the barcode thus presented.
